(19) United States
(12) Patent Application Publication
(10) Pub. No.: US 2024/0095241 A1
(43) Pub. Date: Mar. 21, 2024

(54) DATA SEARCH METHOD AND APPARATUS, AND DEVICE

(71) Applicants: HUAWEI TECHNOLOGIES CO., LTD., Shenzhen (CN); Fudan University, Shanghai (CN)

(72) Inventors: Weiguo Zheng, Shanghai (CN); Yuejia Zhang, Shanghai (CN); Junhua Zhu, Hangzhou (CN)

(21) Appl. No.: 18/520,221

(22) Filed: Nov. 27, 2023

Related U.S. Application Data
(63) Continuation of application No. PCT/CN2022/095028, filed on May 25, 2022.

(30) Foreign Application Priority Data
May 28, 2021 (CN) 202110594906.0

(51) Int. Cl. G06F 16/2453; G06F 16/2455; G06F 16/901

(52) U.S. Cl. CPC G06F 16/24532; G06F 16/24554; G06F 16/9024; G06F 16/9027

(57) ABSTRACT

Embodiments of this disclosure provide a data search method and apparatus, and an electronic device. The method includes obtaining a search request, where the search request includes a query graph formed by a plurality of nodes and a plurality of edges between the plurality of nodes, each node represents an object, and each edge represents an association relationship between objects; determining a plurality of query subgraphs based on the query graph, where each query subgraph includes a group of nodes in the plurality of nodes and edges between the group of nodes, and the plurality of query subgraphs have at least one same node in the plurality of nodes; searching a target data graph in parallel for data subgraphs that respectively match the plurality of query subgraphs; and merging the data subgraphs that respectively match the plurality of query subgraphs, to determine a search result that matches the query graph.

### CROSS-REFERENCE TO RELATED APPLICATIONS

This application is a continuation of International Application No. PCT/CN2022/095028, filed on May 25, 2022, which claims priority to Chinese Patent Application No. 202110594906.0, filed on May 28, 2021, both of which are hereby incorporated by reference in their entireties.

### TECHNICAL FIELD

Embodiments of this disclosure mainly relate to the field of computer technologies, and more specifically, to a data search method and apparatus, and a device.

### BACKGROUND

A graph is an important data representation form in computer science. A relationship between objects is represented by nodes and edges between nodes. Graph models play an important role in various fields such as bioinformatics, chemistry, software engineering, and social networking. In graph analysis, a task of searching a given data graph G for a data subgraph that matches a query graph Q is referred to as “subgraph query”. The found data subgraph and the query graph have subgraph isomorphism. In other words, a one-to-one correspondence exists between nodes and edges. Subgraph query is widely applied to actual scenarios, such as knowledge graph query, protein analysis, pattern matching, and social network analysis.

### SUMMARY

Embodiments of this disclosure provide a method and an apparatus for searching a data graph.

According to a first aspect of this disclosure, a data search method is provided. According to the method, after a search request is obtained, a plurality of query subgraphs are determined based on a query graph in the search request, where the search request includes a query graph formed by a plurality of nodes and a plurality of edges between the plurality of nodes, each node represents an object, each edge represents an association relationship between objects, each query subgraph includes a group of nodes in the plurality of nodes and edges between the group of nodes, and the plurality of query subgraphs have at least one same node in the plurality of nodes. Further, a target data graph is searched in parallel for data subgraphs that respectively match the plurality of query subgraphs, and the data subgraphs that respectively match the plurality of query subgraphs are merged, to determine a search result that matches the query graph.

According to this embodiment of this disclosure, a query task for a query graph may be split into subtasks of a finer granularity, and a plurality of subtasks may be executed in parallel, thereby improving search efficiency. The query graph is appropriately partitioned, so that the query subgraphs have a same partial path (for example, nodes and/or edges), so that efficient parallel search can be implemented, and a quantity of global synchronization times required in the matching process of the query subgraphs is reduced.

In an implementation of the first aspect, that a plurality of query subgraphs are determined based on a query graph includes: performing depth-first search (DFS) on the query graph, to transform the query graph into a tree structure, where the tree structure includes the plurality of nodes in the query graph and at least a part of edges in the plurality of edges; and partitioning the tree structure into the plurality of query subgraphs, where each query subgraph includes nodes and edges on a path from a root node to a leaf node of the tree structure. Therefore, transformation into the tree structure is performed to partition the query graph, and different query subgraphs correspond to different branches in the tree structure. In this way, during matching, for a single query subgraph, a node that matches a next node in the query subgraph is also a neighboring node of a matching node in the target data graph. A partial matching result of a single query subgraph may be transferred between nodes of the query subgraph, so that parallel execution may be performed on the plurality of query subgraphs, and a partial matching result does not need to be synchronized between different search processes, thereby avoiding a redundant intermediate result.

In an implementation of the first aspect, nodes in the plurality of query subgraphs are free of edge constraints across the query subgraphs. In other words, nodes in one query subgraph and nodes in another query subgraph have an edge constraint relationship. The nodes of the query subgraphs obtained through partitioning are free of edge constraints. Therefore, when the edge constraints between the nodes are determined, whether a next node exists in a neighboring node group of the target data graph needs to be detected, so that an operation of intersecting the neighboring set can be implicitly completed, without explicit intersection in a conventional solution.

In another implementation of the first aspect, that a target data graph is searched in parallel for data subgraphs that respectively match the plurality of query subgraphs includes: searching in parallel the target data graph for data subgraphs that respectively match a first query subgraph and a second query subgraph.

In another implementation of the first aspect, the tree structure does not include a first edge in the plurality of edges of the query graph, and a first query subgraph in the plurality of query subgraphs includes a pair of nodes connected through the first edge. In another implementation of the first aspect, that a target data graph is searched in parallel for data subgraphs that respectively match the plurality of query subgraphs includes: searching the target data graph for a candidate data subgraph that matches the first query subgraph; determining whether the candidate data subgraph includes an edge that matches the first edge; and if the candidate data subgraph includes the edge that matches the first edge, determining the candidate data subgraph as a first data subgraph that matches the first query subgraph. Through extra edge verification, the problem of edge constraint loss caused by transformation of the tree structure can be avoided, and accuracy of the matching result can be ensured.

In another implementation of the first aspect, at least two search processes are initiated to search in parallel the target data graph for the plurality of query subgraphs. Through different search processes, parallel search may be implemented in distributed and centralized computation environments.

In another implementation of the first aspect, that a target data graph is searched in parallel for data subgraphs that respectively match the plurality of query subgraphs includes: if a second query subgraph and a third query subgraph in the plurality of query subgraphs include a same partial path starting from a start node, controlling a first search process in the at least two search processes to search the target data graph for a first partial matching subgraph that matches the same partial path; controlling the first search process to search the target data graph for a second partial matching subgraph that matches a path other than the same partial path in the second query subgraph, where the first partial matching subgraph and the second partial matching subgraph are cascaded into a second data subgraph that matches the second query subgraph; and controlling a second search process in the at least two search processes to search the target data graph for a third partial matching subgraph that matches a path other than the same partial path in the third query subgraph, where the first partial matching subgraph and the third partial matching subgraph are cascaded into a third data subgraph that matches the third query subgraph. In the foregoing implementation, the matching result of the same partial path is shared in search processes of different query subgraphs, so that search efficiency can be further improved and consumption of computation resources can be reduced.

In another implementation of the first aspect, at least one of the plurality of query subgraphs has a plurality of matching data subgraphs. The determining a search result that matches the query graph includes: partitioning the data subgraphs that match the plurality of query subgraphs into a plurality of different combinations, where each combination includes different data subgraphs that match each of the plurality of query subgraphs; and separately merging the data subgraphs included in the plurality of combinations, to obtain a plurality of merged data subgraphs as the search result. Through merging and combination, the complete search result for the query graph may be determined.

In another implementation of the first aspect, the determining a search result that matches the query graph includes: merging, through an intersection operation, a group of data subgraphs that match each of the plurality of query subgraphs, to obtain a merged data subgraph. The intersection operation can be quickly invoked to quickly determine the correct search result for the query graph.

In a second aspect of this disclosure, a data search apparatus is provided. The apparatus includes: a request obtaining unit, configured to obtain a search request, where the search request includes a query graph formed by a plurality of nodes and a plurality of edges between the plurality of nodes, each node represents an object, and each edge represents an association relationship between objects; a subgraph determining unit, configured to determine a plurality of query subgraphs based on the query graph, where each query subgraph includes a group of nodes in the plurality of nodes and edges between the group of nodes, and the plurality of query subgraphs have at least one same node in the plurality of nodes; a parallel search unit, configured to search in parallel a target data graph for data subgraphs that respectively match the plurality of query subgraphs; and a result determining unit, configured to merge the data subgraphs that respectively match the plurality of query subgraphs, to determine a search result that matches the query graph.

In an implementation of the second aspect, the subgraph determining unit includes: a tree transformation unit, configured to perform depth-first search (DFS) on the query graph, to transform the query graph into a tree structure, where the tree structure includes the plurality of nodes in the query graph and at least a part of edges in the plurality of edges; and a tree partitioning unit, configured to partition the tree structure into the plurality of query subgraphs, where each query subgraph includes nodes and edges on a path from a root node to a leaf node of the tree structure.

In an implementation of the second aspect, nodes in the plurality of query subgraphs are free of edge constraints across the query subgraphs.

In another implementation of the second aspect, the parallel search unit is configured to search in parallel the target data graph for data subgraphs that respectively match a first query subgraph and a second query subgraph.

In another implementation of the second aspect, the tree structure does not include a first edge in the plurality of edges of the query graph, and a first query subgraph in the plurality of query subgraphs includes a pair of nodes connected through the first edge. In another implementation of the second aspect, the parallel search unit includes: a candidate search unit, configured to search the target data graph for a candidate data subgraph that matches the first query subgraph; a match determining unit, configured to determine whether the candidate data subgraph includes an edge that matches the first edge; and a candidate determining unit, configured to: if the candidate data subgraph includes the edge that matches the first edge, determine the candidate data subgraph as a first data subgraph that matches the first query subgraph.

In another implementation of the second aspect, at least two search processes are initiated to search in parallel the target data graph for the plurality of query subgraphs.

In another implementation of the second aspect, the parallel search unit includes: a first control unit, configured to: if a second query subgraph and a third query subgraph in the plurality of query subgraphs include a same partial path starting from a start node, control a first search process in the at least two search processes to search the target data graph for a first partial matching subgraph that matches the same partial path; a second control unit, configured to control the first search process to search the target data graph for a second partial matching subgraph that matches a path other than the same partial path in the second query subgraph, where the first partial matching subgraph and the second partial matching subgraph are cascaded into a second data subgraph that matches the second query subgraph; and a third control unit, configured to control a second search process in the at least two search processes to search the target data graph for a third partial matching subgraph that matches a path other than the same partial path in the third query subgraph, where the first partial matching subgraph and the third partial matching subgraph are cascaded into a third data subgraph that matches the third query subgraph.

In another implementation of the second aspect, at least one of the plurality of query subgraphs has a plurality of matching data subgraphs. The result determining unit includes: a combination unit, configured to partition the data subgraphs that match the plurality of query subgraphs into a plurality of different combinations, where each combination includes different data subgraphs that match each of the plurality of query subgraphs; and a combination merging unit, configured to separately merge the data subgraphs included in the plurality of combinations, to obtain a plurality of merged data subgraphs as the search result.

In another implementation of the second aspect, the result determining unit is configured to merge, through an intersection operation, a group of data subgraphs that match each of the plurality of query subgraphs, to obtain a merged data subgraph.

According to a third aspect of this disclosure, an electronic device is provided. The electronic device includes at least one computation unit and at least one memory. The at least one memory is coupled to the at least one computation unit, and stores instructions executed by the at least one computation unit. When the instructions are executed by the at least one computation unit, the device is enabled to perform the method in any one of the first aspect or the implementations of the first aspect.

According to a fourth aspect of this disclosure, a computer-readable storage medium is provided. The computer-readable storage medium stores one or more computer instructions. The one or more computer instructions are executed by a processor to implement the method in any one of the first aspect or the implementations of the first aspect.

According to a fifth aspect of this disclosure, a computer program product is provided. The computer program product includes computer-executable instructions. When the computer-executable instructions are executed by a processor, the computer is enabled to perform instructions of some or all steps of the method in any one of the first aspect or the implementations of the first aspect.

It may be understood that the data search apparatus in the second aspect, the electronic device in the third aspect, the computer storage medium in the fourth aspect, or the computer program product in the fifth aspect provided above is used to implement the method according to the first aspect. Therefore, the explanation or description of the first aspect is also applicable to the second aspect, the third aspect, the fourth aspect, and the fifth aspect. In addition, for beneficial effects that can be achieved in the second aspect, the third aspect, the fourth aspect, and the fifth aspect, refer to beneficial effects in corresponding methods. Details are not described herein again.

It is clearer and easier to understand the foregoing and other aspects of the present disclosure in descriptions of the following (plurality of) embodiments.

### BRIEF DESCRIPTION OF DRAWINGS

The foregoing and other features, advantages, and aspects of embodiments of this disclosure are described in conjunction with the accompanying drawings. In the accompanying drawings, same or similar reference numerals represent same or similar elements.

FIG. 1A is a schematic diagram of an example environment in which a plurality of embodiments of this disclosure can be implemented;

FIG. 1B is a schematic diagram of another example environment in which a plurality of embodiments of this disclosure can be implemented;

FIG. 2 is a flowchart of a data search process according to some embodiments of the disclosure;

FIG. 3A to FIG. 3E are example diagrams of a data search process according to some embodiments of this disclosure;

FIG. 4 is a block diagram of a data search apparatus according to some embodiments of this disclosure; and

FIG. 5 is a block diagram of an example device that may be used to implement embodiments of this disclosure.

### DESCRIPTION OF EMBODIMENTS

The following describes embodiments of this disclosure in detail with reference to the accompanying drawings. Although some embodiments of this disclosure are shown in the accompanying drawings, it should be understood that this disclosure may be implemented in various forms, and should not be construed as being limited to the embodiments described herein. On the contrary, these embodiments are provided so that this disclosure will be thoroughly understood. It should be understood that the accompanying drawings and embodiments of this disclosure are merely used as examples, but are not intended to limit the protection scope of this disclosure.

In descriptions of embodiments of this disclosure, the term “include” and similar terms thereof should be understood as open inclusion, that is, “include but are not limited to”. The term “based” should be understood as “at least partially based”. The terms “one embodiment” or “the embodiment” should be understood as “at least one embodiment”. The terms “first”, “second”, and the like may indicate different or same objects. Other explicit and implicit definitions may also be included below.

In this specification, a “graph” is an abstract data type, and can indicate a plurality of objects and an association relationship between the plurality of objects. In some embodiments, nodes and edges of a graph 105 may also have associated attributes or features. An object may be represented as a node (also referred to as a vertex) in a graph, and a connection relationship between objects may be represented as an edge that connects nodes in the graph. The graph may be represented by a tuple (V, E), where V is referred to as a node set, and E is referred to as an edge set. The graph may be classified into a directed graph and an undirected graph. In subgraph query application, a “data graph” is given target data, and a “query graph” is a graph part to be searched for in the data graph.

The graph may exist in many actual applications and scenarios. If necessary, both an object and an association relationship between objects may be represented by the graph. For example, in a knowledge graph, nodes in the graph represent various entities, edges represent association relationships between these entities, and specific attributes may also be marked. In protein analysis, nodes in the graph represent components of protein, and edges represent connection relationships between these components. In pattern matching, nodes in the graph represent elements in a pattern, and edges represent connection relationships between the elements. In social network analysis, nodes in the graph may represent objects such as a person and an organization, and edges represents social relationships between these objects.

As a data volume of each domain increases sharply, a scale of graphs is increasing, and search efficiency of large-scale data graphs becomes a problem. First, a large-scale graph (for example, a social network graph with billions of nodes) may not be able to be stored in a random access memory. If the graph is stored in an external storage, read and write data does not comply with a locality principle, resulting in performance bottlenecks. Second, even if a large-scale graph can be stored in the memory, an existing single-machine subgraph query algorithm usually depends on a superlinear index structure. However, this index cannot be implemented on the large-scale graph.

In a conventional solution, to resolve a problem of search efficiency, the large-scale graph is stored in different storage locations in a distributed manner, and a distributed computation system is used to implement parallelization between a plurality of query graphs, thereby improving computation efficiency. However, for a single query graph, searches still need to be performed consecutively to obtain a correct search result.

According to embodiments of this disclosure, an improved data search solution is proposed. According to this solution, a query graph is partitioned into a plurality of query subgraphs in a manner, for example, based on depth-first search (DFS). In this way, the plurality of query subgraphs have at least one same node. A target data graph is searched in parallel for data subgraphs that respectively match the plurality of query subgraphs, so that parallel search efficiency can be significantly improved. The obtained data subgraphs are merged to determine a search result that matches the query graph. In this solution, a query task for a query graph is split into subtasks of a finer granularity, and the plurality of subtasks may be executed in parallel, thereby improving search efficiency.

The following describes in detail example embodiments of this disclosure with reference to the accompanying drawings.

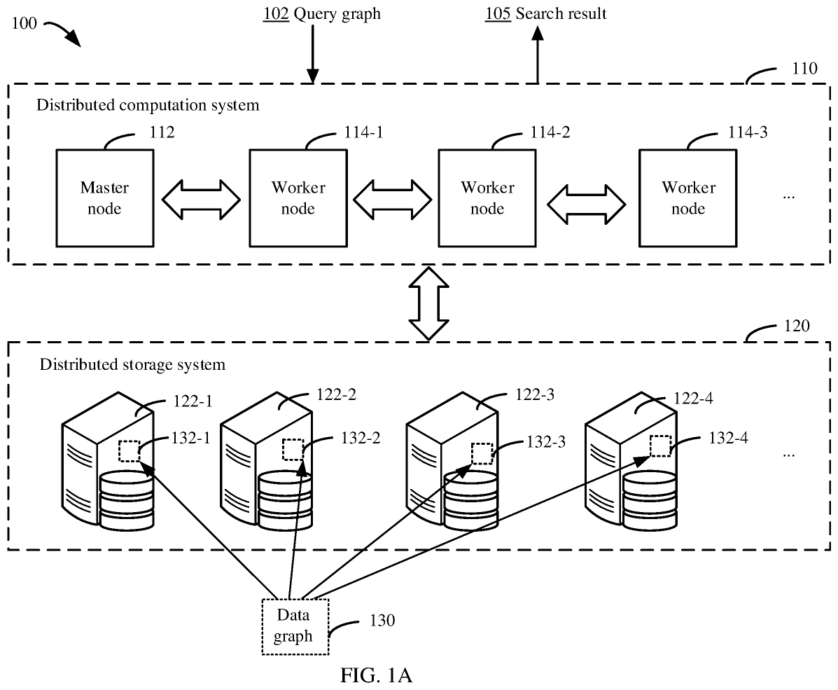

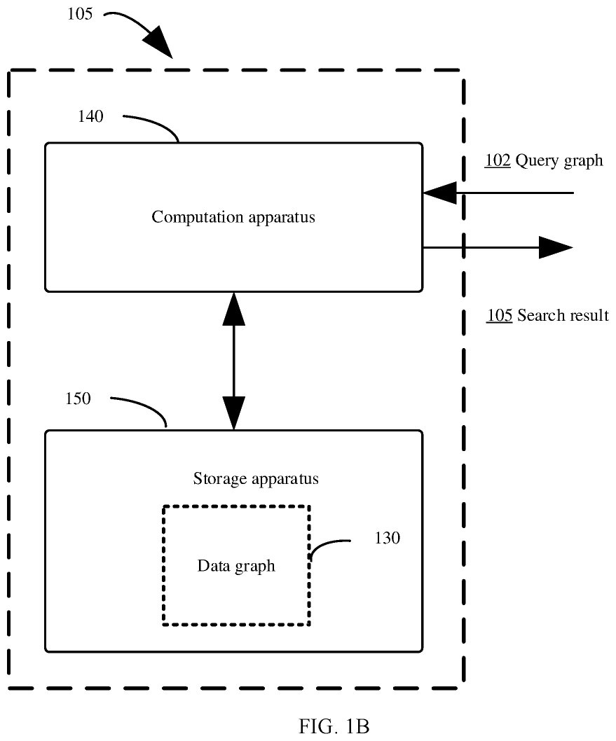

FIG. TA and FIG. 1B respectively are schematic diagrams of example computation environments in which a plurality of embodiments of this disclosure can be implemented. A data search process for a query graph provided in this embodiment of this disclosure may be implemented in any computation environment in FIG. TA and FIG. 1B.

FIG. TA illustrates a distributed computation environment 100, including a distributed computation system 110 and a distributed storage system 120. The distributed computation system 110 includes a master node 112 and a plurality of worker nodes 114-1, 114-2, 114-3 (for ease of description, collectively referred to as or individually referred to as a worker node 114), and the like. The master node 112 and the worker nodes 114 may be configured to execute a computation task. The master node 112 may control and manage a request for a task, distribution of a task to the worker nodes 114, coordination between the worker nodes 114, and the like. The worker node 114 may perform one or more computation operations based on a request of the master node 112. The master node 112 and the worker node 114 may include any physical device or virtual device having a computation capability, such as a server, a mainframe, a general-purpose computer, a virtual machine, or the like.

The distributed storage system 120 includes a plurality of storage apparatuses 122-1, 122-2, 122-3, 122-4 (for ease of description, collectively referred to as or individually referred to as the storage apparatus 122), and the like, and is configured to provide a data storage capability. The distributed storage system 120 may implement distributed data storage by using various storage technologies. Such storage technologies include, for example, a Hadoop distributed file system (HDFS) and a distributed database (DB).

In subgraph query application, the data graph 130 may be stored in a distributed manner. For example, as shown in the figure, different parts 133-1, 132-2, 132-3, 132-4, and the like of the data graph 130 may be respectively stored in the plurality of storage apparatuses 112-1, 112-2, 112-3, and 112-4. This is particularly advantageous in a case of the large-scale data graph. Certainly, a distribution manner of the data graph 130 in the distributed storage system 120 depends on an applied storage technology, and this embodiment of this disclosure is not limited in this aspect. When search is performed, the distributed computation system 110 accesses each to-be-matched part of the data graph 130 by using a respective storage apparatus 112.

The distributed computation system 110 may receive a search request, where the search request indicates a query graph 102. The master node 112 and the worker nodes 114 in the distributed computation system 110 may search the data graph 130 for data subgraphs that match the query graph 102, and provide a search result 105. The master node 112 and the worker nodes 114 may search in parallel the query graph 102 to provide higher query efficiency, as described in detail below.

FIG. 1B illustrates a centralized computation environment 105 that includes a computation apparatus 140 and a storage apparatus 150. In the example of FIG. 1B, a data graph 130 is stored in the storage apparatus 150 in a centralized manner. The computation apparatus 140 may receive a query graph 102 to be searched for, and access the data graph 130 through the storage apparatus 150. Because the data graph 130 is stored in the centralized manner, the computation apparatus 140 may more quickly access a to-be-matched data part, and perform matching. The computation apparatus 140 may search in parallel the query graph 102 to provide higher query efficiency, as described in detail below. After matching is completed, the computation apparatus 140 provides a search result 105. The computation apparatus 140 may include any physical device or virtual device having a computation capability, such as a server, a mainframe, a general-purpose computer, a virtual machine, or the like.

Although the distributed and centralized computation environments are shown in FIG. 1A and FIG. 1B respectively, in another embodiment, a distributed computation system may access data stored in a centralized manner, and a single computation apparatus configured to perform data search may access data in a distributed storage system.

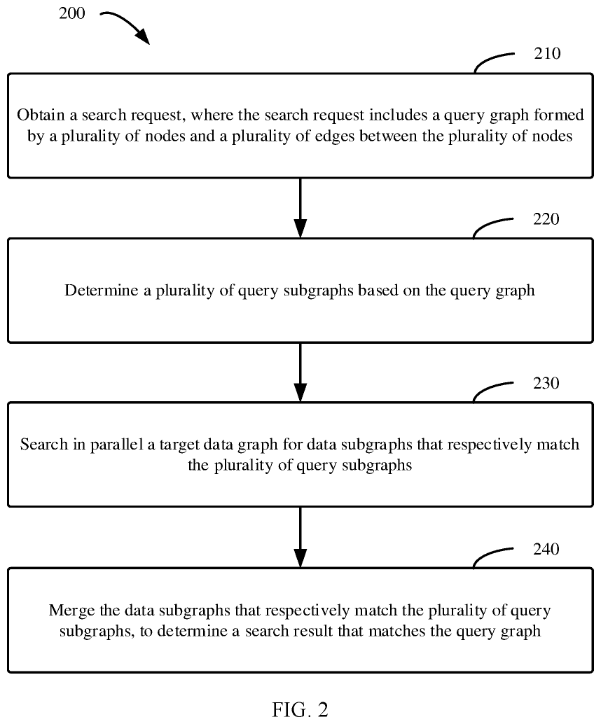

FIG. 2 is a flowchart of a data search process 200 according to some embodiments of the disclosure. For example, the process 200 may be performed by the distributed computation system 110 in FIG. 1A or the computation apparatus 140 in FIG. 1B. For ease of description, the following describes the process 200 with reference to FIG. 1A or FIG. 1B.

In a block 210, the distributed computation system 110 or the computation apparatus 140 obtains a search request. The search request includes a query graph 102 to request to search for the query graph 102. In this specification, the query graph 102 includes a plurality of nodes and a plurality of edges between the plurality of nodes, where each node represents an object, and each edge represents an association relationship between objects. In some examples, a node may have an edge connected to the node.

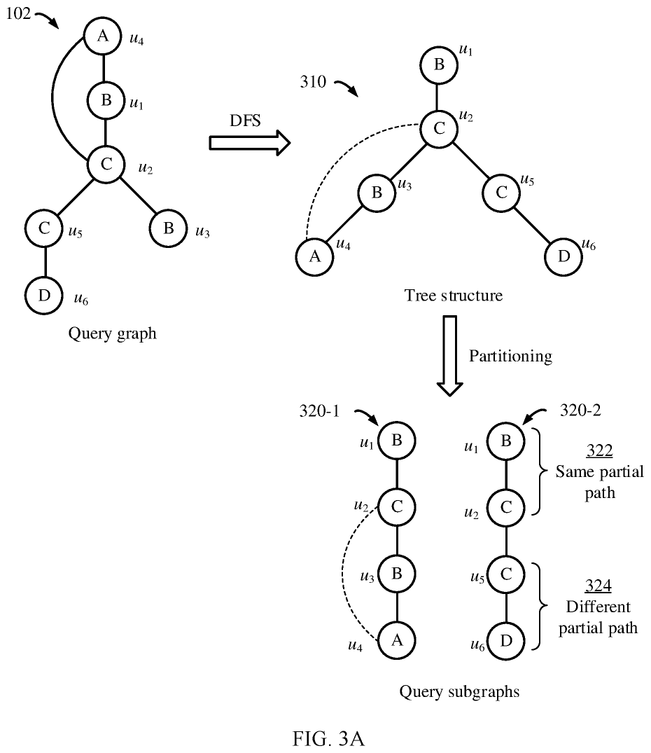

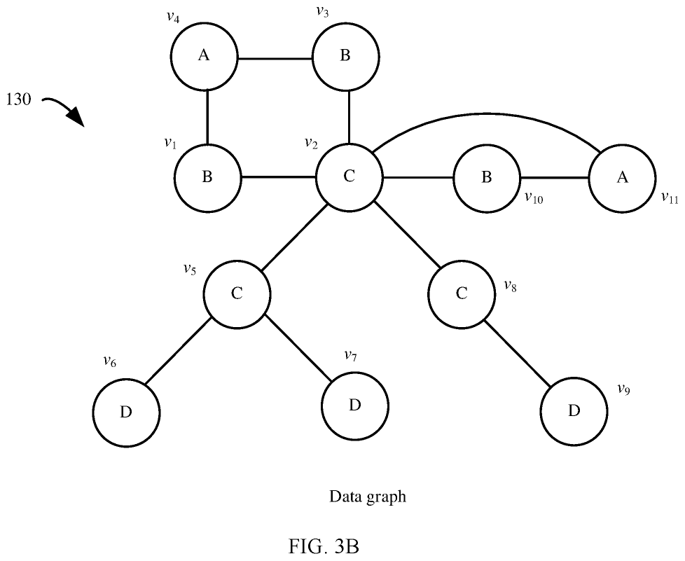

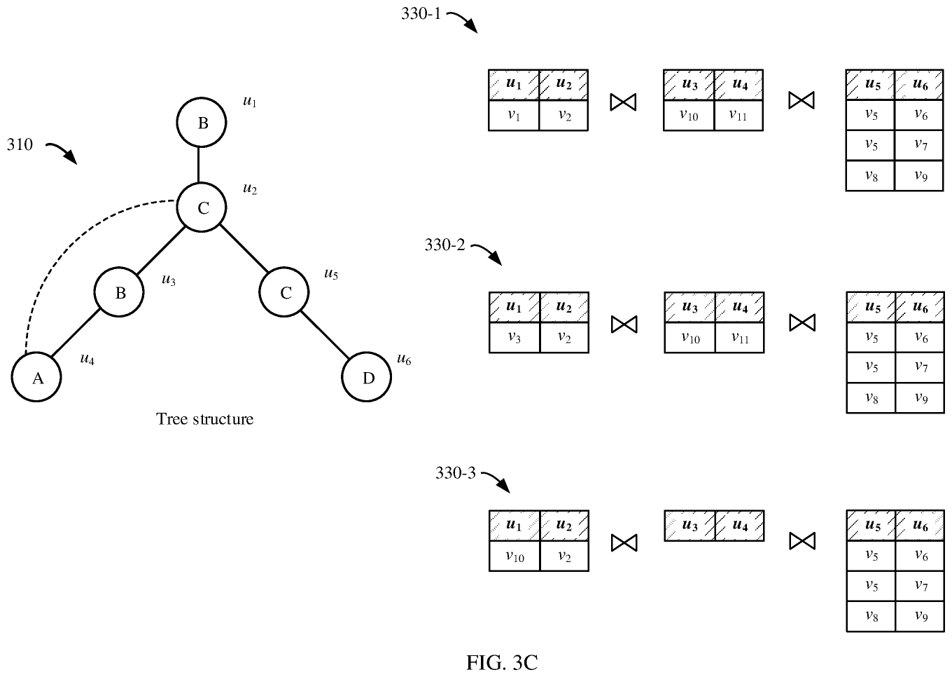

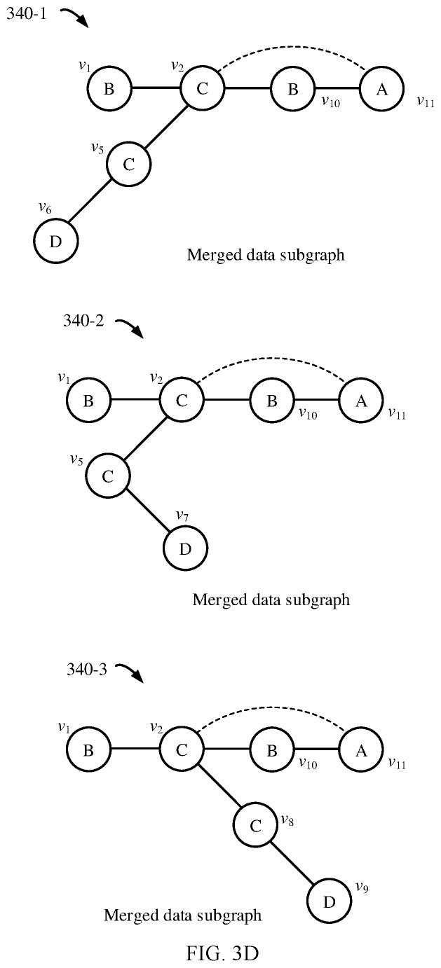

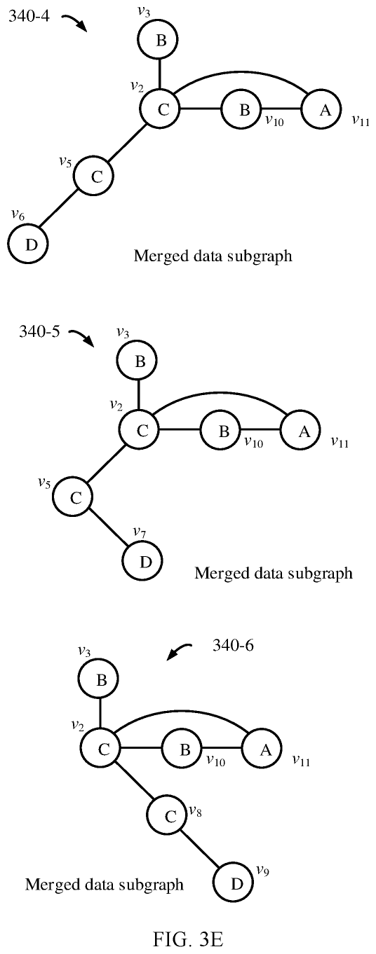

FIG. 3A illustrates an example of the query graph 102 that includes a plurality of nodes represented by labels A, B, C, D, and the like. The nodes are connected through edges. It should be noted that, in FIG. 3A, nodes with a same label (for example, A, B, C, or D) are repeatedly present, and all are the same node. However, it indicates that the nodes present in different locations are connected to other different nodes through different edges. FIG. 3A merely illustrates one representation form of the query graph 102. The query graph 102 may alternatively be represented in another form. It should be understood that FIG. 3A and the data graph 130 shown subsequently are provided only as examples to better understand embodiments of this disclosure. Neither a quantity of nodes nor connection relationships between the nodes shown in the figure constitutes a limitation on this disclosure.

In a block 220, the distributed computation system 110 or the computation apparatus 140 determines a plurality of query subgraphs based on the query graph 102.

As briefly described above, in embodiments of this disclosure, a search task for a single query graph 102 needs to be partitioned into a plurality of subtasks for parallel execution. Therefore, the query graph 102 is partitioned into the plurality of query subgraphs, so that a search for a single or partial query subgraph can be performed in each subtask. Each query subgraph obtained through partitioning includes a group of nodes in the plurality of nodes and edges between the group of nodes in the query graph 102, and the plurality of query subgraphs have at least one same node in the plurality of nodes.

The inventor finds that, when the query graph is partitioned into the plurality of query subgraphs, if the query graph is only partitioned into non-overlapping parts, a large quantity of redundant intermediate matching results may be generated. The parts obtained through partitioning have edge constraint relationships. Therefore, the intermediate matching results determined for these parts are not a matching result of the query graph. Consequently, a large quantity of verifications need to be performed on the intermediate matching results.

In this embodiment of this disclosure, when the query graph 102 is partitioned, partitioning is performed in a particular manner starting from a node in the query graph 102, so that the plurality of query subgraphs have at least one same node. In some embodiments, when the query graph 102 is partitioned, nodes in the plurality of query subgraphs are free of edge constraints across the query subgraphs. In other words, nodes in one query subgraph and nodes in another query subgraph have an edge constraint relationship.

In some embodiments, query graph partitioning based on depth-first search (DFS) is proposed. Specifically, DFS may be performed on the query graph 102, the query graph 102 is transformed into a tree structure, and the tree structure is partitioned into a plurality of query subgraphs.

In this specification, the “tree structure” or a “tree” is a group of nodes that have a hierarchical relationship. The “tree” indicates that the structure looks like a tree hanging upside down, with its roots facing up and its leaves facing down. Some features of the tree structure include: Each node is connected to a limited quantity of child nodes or has no child node; a node without a parent node is referred to as a root node; a node without a child node is referred to as a leaf node; each non-root node has only one parent node; each child node other than the root node may be partitioned into a plurality of non-intersecting subtrees; and no loop exists in the tree.

DFS is an algorithm used to traverse or search for trees or graphs. This algorithm searches for branches of the tree as deep as possible. After edges on which a node v in the graph is located are accessed, the search traces back to a start node of an edge on which the node v is found. This process continues until all nodes that are reachable from a source node are found. If there are still nodes that have not been found, one of the nodes is selected as a source node, and the foregoing process is repeated. The entire process is repeated until all nodes are accessed. In some embodiments, after DFS is performed on the query graph 102, the query graph 102 may be transformed into a tree structure in an access sequence of nodes in a DFS traversal process.

In FIG. 3A, after DFS is performed on the query graph 102, a plurality of nodes are marked as u₁, u₂, u₃, u₄, u₅, and u₆ in an access sequence, and may be transformed into a tree structure 310. The access sequence and a node name can uniquely identify a node and connection relationships between the node and different edges. As shown in the figure, a root node of the tree structure 310 is a node B u₁. Starting from a non-root node C u₂, the tree structure 310 includes two path branches.

When the tree structure is partitioned into a plurality of query subgraphs, each query subgraph may include nodes and edges on a path from a root node to a leaf node of the tree structure. In this way, the plurality of query subgraphs obtained through partitioning from the query graph 102 have at least the same root node. In some cases, depending on the tree structure, a plurality of query subgraphs may share one or more non-root nodes in addition to the root node. In this way, the plurality of query subgraphs have a same partial path and also have a different partial path. The tree structure generated through DFS may have the following features: Two nodes connected through a non-tree edge certainly are an ancestor and a descendant. Therefore, different paths in the tree structure have an edge constraint relationship, so that desired query subgraphs can be quickly obtained through partitioning.

In the example of FIG. 3A, a query subgraph 320-1 may be obtained by partitioning along a left branch path of the node C u₂ starting from the root node B u₁ of the tree structure 310. In addition, a query subgraph 320-2 may also be obtained by partitioning along a right branch path of the node C u₂ starting from the root node B u₁ of the tree structure 310. The query subgraphs 320-1 and 320-2 (sometimes referred to as a query subgraph 320 for ease of description) include a same partial path 322 starting from a start node (namely, the root node in the tree structure), including the root node B u₁ and the node C u₂ connected to the root node. In addition, the query subgraphs 320-1 and 320-2 further include different partial paths 324. A different partial path 324 in the query subgraph 320-1 includes a node B u₃ connected to the node C u₂ and a node A u₄ connected to the node B u₃. A different partial path 324 in the query subgraph 320-2 includes a node C u₅ connected to the node C u₂ and a node D u₆ connected to the node C u₅.

In some embodiments, after transformation, the tree structure may not include one or more edges in the query graph 102. In other words, the tree structure includes all the nodes in the query graph 102, but the one or more edges of these nodes may not be included in the tree structure. For example, in FIG. 3A, the node C u₂ and the node A u₄ in the query graph 102 are connected through an edge, but when the query graph is transformed into the tree structure 310, the edge between the node C u₂ and the node A u₄ is not included in the tree structure. Such an edge is referred to as a “non-tree edge”. If an edge is lost, the plurality of query subgraphs obtained through partitioning from the tree structure have no constraints of this edge. Specifically, the edge is lost in a query subgraph including two nodes connected through the edge. In FIG. 3A, in the tree structure 310 and the query subgraph 320-1, the non-tree edge is represented by a dashed line.

In some embodiments, to improve accuracy of the matching result, the non-tree edge in the query subgraph may be recorded, and after a partial matching result of the query subgraph is obtained, verification for the non-tree edge is performed, to determine whether the partial matching result satisfies edge constraints of the two nodes in the query graph 102. Exemplary verification for the non-tree edge is described in detail below.

In a block 230, the distributed computation system 110 or the computation apparatus 140 searches in parallel a target data graph for data subgraphs that respectively match the plurality of query subgraphs.

The data graph to be searched (namely, the target data graph) may be specified by a search requester, or may be determined in another manner (for example, through the search of all stored data graphs). In the environments in FIG. TA and FIG. 1B, it is assumed that the data graph 130 is the target data graph to be searched. The plurality of query subgraphs may be separately searched for. Therefore, to improve search efficiency, searches may be performed in parallel.

In some embodiments, at least two search processes may be initiated to search in parallel the target data graph 130 for the plurality of query subgraphs. For example, different search processes may search in parallel for different query subgraphs. For example, in the distributed computation environment in FIG. TA, the master node 112 in the distributed computation system 110 may control different worker nodes 114 to initiate different search processes. In some examples, the master node 112 may partition the query graph 102 into a plurality of query subgraphs and send the plurality of query subgraphs to the respective worker nodes 114 for parallel search. In the example computation environment in FIG. 1B, the computation apparatus 140 may use a parallel computation capability to initiate a plurality of search processes to quickly complete the search.

In some embodiments, a quantity of initiated search processes may be equal to a quantity of query subgraphs, so that a single search process may search for a single query subgraph. In some other embodiments, a quantity of initiated search processes may alternatively be less than a quantity of query subgraphs. For example, a single search process may search for two or more query subgraphs in the plurality of query subgraphs. These depend on the computation capability and configuration.

In some embodiments, the target data graph 130 may be stored in a local storage space for the plurality of search processes executed in parallel. Compared with storage in a distributed database, this manner greatly shortens the time for data access. Data graphs do not need to be transferred between machines, so that the amount of transmitted information can be reduced.

In a search for a query subgraph, starting from a start node of the query subgraph (for example, the root node of the tree structure), a node that matches the start node may be determined in the target data graph 130 as a partial matching subgraph. Then, a node that matches a next node of the query subgraph is searched for from one or more neighboring nodes connected to the matching node in the target data graph 130, to be added to the partial matching subgraph. By repeating such steps, nodes are continuously added to the partial matching subgraph. After all the nodes of the query subgraph and the edge constraints are detected, the final partial matching subgraph may be used as the data subgraph that matches the query subgraph.

As mentioned above, nodes of the query subgraphs obtained through partitioning have no edge constraints. Especially in an embodiment in which query graph partitioning is performed based on the tree structure obtained through DFS, different query subgraphs respectively correspond to different branches in the tree structure. Therefore, during matching, for a single query subgraph, a node that matches a next node in the query subgraph is also a neighboring node of a matching node in the target data graph. A partial matching result of the single query subgraph may be transferred between nodes of the query subgraph. Such a query policy is different from consecutively matching nodes in the entire query graph. In this embodiment of this disclosure, the query subgraphs obtained through partitioning may be searched for in parallel. In a parallel search process, the partial matching results (for example, the partial matching subgraphs) do not need to be synchronized between the different search processes. This avoids redundant intermediate results. A single search process may complete matching of a single query subgraph. As described below, matching results obtained in the plurality of search processes may be sent to a search process for aggregation, thereby obtaining a final matching result for the query graph 102.

In some embodiments, if a query subgraph in the plurality of query subgraphs includes a “non-tree edge”, that is, if the query subgraph obtained through partitioning from the tree structure does not include an edge between two nodes originally in the query graph 102, further verification needs to be performed on a result that matches the query subgraph and that is obtained by searching the data graph 130. Specifically, the target data graph 130 may be searched for one or more candidate data subgraphs that match the query subgraph, and whether each candidate data subgraph includes an edge that matches the “non-tree edge” is determined. During edge matching, nodes that match the two nodes connected through the “non-tree edge” in the query subgraph are identified in the candidate data subgraph, and then it is determined whether the two nodes in the candidate data subgraph are connected through an edge. Therefore, if the candidate data subgraph includes an edge that matches the “non-tree edge”, the candidate data subgraph is determined as a data subgraph that matches the query subgraph. Candidate data subgraphs that do not include an edge that matches the “non-tree edge” are deleted. In some embodiments, if there are a plurality of “non-tree edges” in a query subgraph or each of the plurality of query subgraphs has a “non-tree edge”, verification may be performed in a similar manner.

In some cases, two or more query subgraphs may include a same partial path starting from the start node, for example, a same partial path 322 in the example of FIG. 3B. To improve search efficiency and reduce consumption of computation resources, in some embodiments, the same partial path may be queried as a shared query task in a single search process. The partial matching result obtained for the same partial path may be shared among the plurality of search processes. Then, the plurality of search processes may search in parallel for other paths in the query subgraphs based on the partial matching result.

Specifically, if two or more query subgraphs may include the same partial path starting from the start node, one of the search processes may be first controlled to search the target data graph 130 for a first partial matching subgraph that matches the partial same path. Then, the search process may continue to search the target data graph 130 for a second partial matching subgraph that matches a path other than the same partial path in one query subgraph, and cascade the first partial matching subgraph and the second partial matching subgraph into a data subgraph that matches the query subgraph. Another search process may be controlled to search the target data graph 130 for a third partial matching subgraph that matches a path other than the same partial path in another query subgraph, and cascade the first partial matching subgraph and the third partial matching subgraph into a data subgraph that matches a corresponding query subgraph. If the same partial path exists in more than two query subgraphs, another search process may similarly search for a path other than the same partial path in a corresponding query subgraph, and cascade a first partial matching subgraph and a found partial matching subgraph into a data subgraph that matches the corresponding query subgraph.

It should be understood that, in another embodiment, the partial matching result for the same partial path may not be shared, and the plurality of search processes may separately search in parallel for query subgraphs with the same partial path.

For better understanding of the search process in the foregoing embodiment, refer to the accompanying drawings for description.

FIG. 3B illustrates an example target data graph 130 that includes a plurality of nodes represented by labels A, B, C, D, and the like. The nodes are connected through edges. It should be noted that, in FIG. 3B, nodes with a same label (for example, A, B, C, or D) are repeatedly present, and all are the same node. However, it indicates that the nodes present in different locations are connected to other different nodes through different edges. Therefore, in the graph, vᵢ (i=1 to 9) indicates different nodes connected through different edges.

The target data graph 130 in FIG. 3B is expected to be searched for data subgraphs that respectively match the query subgraphs 320-1 and 320-2 shown in the example of FIG. 3A. The distributed computation system 110 or the computation apparatus 140 may initiate two search processes to search in parallel for the query subgraphs 320-1 and 320-2.

Specifically, because the query subgraphs 320-1 and 320-2 have the same partial path 322, one search process may be initiated to perform matching starting from the root node B u₁. In the example target data graph 130 in FIG. 3B, nodes (v₁, v₃, v₁₀) with a label B may be searched for to match the node B u₁ in the query subgraph, to obtain partial matching results (v₁, v₃, v₁₀). Each node is considered as a point in a partial matching subgraph.

Then, in the target data graph 130, whether neighboring nodes connected to the nodes (v₁, v₃, v₁₀) with the label B include a node that matches the next node C u₂ of the node B u₁ continues to be detected through searching. In the target data graph 130, the nodes (v₁, v₃, v₁₀) are all connected to a node (v₂) with a label C. The node matches the node C u₂ in the query subgraph. In this case, the nodes (v₁, v₃, v₁₀) with the label B and the neighboring node (v₂) with the label C in the target data graph 130 certainly have an edge constraint relationship. This relationship can also match the edge constraint relationship between the node B u₁ and the node C u₂ in the query subgraph. Three partial matching subgraphs {v₁, v₂}, {v₃, v₂}, and {v₁₀, v₂} may be obtained by adding matching nodes.

The three partial matching subgraphs are used as matching results of the same partial path 322. Then, in some examples, two search processes may be used to search in parallel for different partial paths 324 of the query subgraphs 320-1 and 320-2.

Specifically, for the query subgraph 320-1, whether neighboring nodes connected to the node (v₂) with the label C in the target data graph 130 include a node that matches the next node B u₃ in the query subgraph 320-1 is detected through searching. In the example in FIG. 3B, the matching nodes (v₁, v₃, v₁₀) with the label B may be found. After a node (v₁) with the label B is added to a previous partial matching subgraph, two updated partial matching subgraphs {v₃, v₂, v₁} and {v₁₀, v₂, v₁} may be obtained. After a node (v₃) with the label B is added to a previous partial matching subgraph, two updated partial matching subgraphs {v₁, v₂, v₃} and {v₁₀, v₂, v₃} may be obtained. After a node (v₁₀) with the label B is added to a previous partial matching subgraph, two updated partial matching subgraphs {v₁, v₂, v₁₀} and {v₃, v₂, v₁₀} may be obtained.

For all the six obtained partial matching subgraphs, whether neighboring nodes connected to a last node in each partial matching subgraph include a node that matches the next node A u₄ in the query subgraph 320-1 may continue to be detected through searching. In the example in FIG. 3B, matching nodes (v₄, v₁₁) with a label A may be found.

For a node (v₄) with the label A, last nodes of the previous four partial matching subgraphs {v₃, v₂, v₁}, {v₁₀, v₂, v₁}, {v₁, v₂, v₃}, and {v₁₀, v₂, v₃} are all connected to the node A (v₄). After the node A (v₄) is added, the four partial matching subgraphs are updated to {v₃, v₂, v₁, v₄}, {v₁₀, v₂, v₁, v₄}, {v₁, v₂, v₃, v₄}, and {v₁₀, v₂, v₃, v₄} that are used as candidate data subgraphs for the query subgraph 320-1. Considering that a “non-tree edge” exists between the node A u₄ and the node C u₂ in the query subgraph 320-1, verification may be performed in the candidate data subgraphs. It is found through verification that the node C v₂ and the node A v₄ that respectively match the node C u₂ and the node A u₄ in the four candidate data subgraphs have no edge constraints. Therefore, these candidate data subgraphs fail to be matched and cannot be used as a data subgraph that matches the query subgraph 320-1.

For a node (v₁₁) with the label A, last nodes of the previous two partial matching subgraphs {v₁, v₂, v₁₀} and {v₃, v₂, v₁₀} are all connected to the node A (v₁₁). After the node A (v₁₁) is added, the four partial matching subgraphs are updated to {v₁, v₂, v₁₀, v₁₁} and {v₃, v₂, v₁₀, v₁₁} that are used as candidate data subgraphs for the query subgraph 320-1. Verification for a “non-tree edge” may be further performed on these partial matching subgraphs. It is found through verification that the node C v₂ and the node A v₁₁ that respectively match the node C u₂ and the node A u₄ in the four candidate data subgraphs have edge constraints. Therefore, these candidate data subgraphs may be determined as a data subgraph that matches the query subgraph 320-1.

When the query subgraphs 320 are searched for in parallel, starting from the partial matching subgraph {v₁, v₂}, {v₃, v₂}, and {v₁₀, v₂} that matches the same partial path 322, whether neighboring nodes connected to the node (v₂) with the label C in the target data graph 130 include a node that matches the next node C u₅ in the query subgraph 320-2 is detected through searching. In the example in FIG. 3B, matching nodes (v₅, v₈) with the label C may be found. After a node (v₅) with the label C is added to a previous partial matching subgraph, three updated partial matching subgraphs {v₁, v₂, v₅}, {v₃, v₂, v₅}, and {v₁₀, v₂, v₅} may be obtained. After a node (v₈) with the label C is added to a previous partial matching subgraph, three updated partial matching subgraphs {v₁, v₂, v₈}, {v₃, v₂, v₈}, and {v₁₀, v₂, v₈} may be obtained.

For all the six obtained partial matching subgraphs, whether neighboring nodes connected to a last node in each partial matching subgraph include a node that matches the next node D u₆ in the query subgraph 320-2 may continue to be detected through searching. In the example in FIG. 3B, matching nodes (v₆, v₇, v₉) with a label D may be found.

For a node (v₆) with the label D, last nodes of the previous three partial matching subgraphs {v₁, v₂, v₅}, {v₃, v₂, v₅}, and {v₁₀, v₂, v₅} are all connected to the node D (v₆). After the node D (v₆) is added, the three partial matching subgraphs are updated to {v₁, v₂, v₅, v₆}, {v₃, v₂, v₅, v₆}, and {v₁₀, v₂, v₅, v₆}. For a node (v₇) with the label D, last nodes of the previous three partial matching subgraphs {v₁, v₂, v₅}, {v₃, v₂, v₅}, and {v₁₀, v₂, v₅} are all connected to the node D (v₆). After the node D (v₆) is added, the three partial matching subgraphs are updated to {v₁, v₂, v₅, v₇}, {v₃, v₂, v₅, v₇}, and {v₁₀, v₂, v₅, v₇}. For a node (v₇) with the label D, last nodes of the previous three partial matching subgraphs {v₁, v₂, v₅}, {v₃, v₂, v₅}, and {v₁₀, v₂, v₅} are all connected to the node D (v₉). After the node D (v₉) is added, the three partial matching subgraphs are updated to {v₁, v₂, v₈, v₉}, {v₃, v₂, v₈, v₉}, and {v₁₀, v₂, v₈, v₉}. Because the query subgraph 320-2 is not marked with a “non-tree edge”, additional verification does not need to be performed on these partial matching subgraphs. Therefore, all the nine partial matching subgraphs may be determined as a data subgraph that matches the query subgraph 320-2.

Still refer to FIG. 2. In the process 200, after the search of the query subgraphs is completed, in a block 240, the distributed computation system 110 or the computation apparatus 140 merges the data subgraphs that respectively match the plurality of query subgraphs to determine a search result that matches the query graph 102. In some embodiments, the data subgraphs obtained by different search processes may be provided to a search process for merging. For example, in the example environment in FIG. TA, different worker nodes 114 may provide the master node 112 with the data subgraphs that are searched out for the query subgraphs respectively. In the example environment in FIG. 1B, the computation apparatus 140 may perform a search process of a query subgraph or initiate a new search process to merge the data subgraphs.

In this embodiment of this disclosure, after the plurality of query subgraphs are searched for in parallel, the data subgraphs that match the query subgraphs are summarized and merged, so that a size of an intermediate result can be further reduced, and there is no need to perform cross-subgraph splicing for a plurality of times in an intermediate search process.

Specifically, when the data subgraphs that respectively match the plurality of query subgraphs are merged, a merged data subgraph that matches the complete query graph 102 may be determined through an intersection operation. The target data subgraph and the query graph 102 have subgraph isomorphism, and a one-to-one correspondence exists between nodes and edges. In the intersection operation, if a query subgraph has a plurality of matching data subgraphs, these data subgraphs may be combined with data subgraphs that match other query subgraphs to obtain a plurality of combinations, where each combination includes different data subgraphs that match each of the plurality of query subgraphs. Then, the data subgraphs included in the plurality of combinations may be separately merged, to obtain a plurality of merged data subgraphs as the search result.

FIG. 3C illustrates an example of merging a plurality of data subgraphs. In FIG. 3C, a tree structure 310 obtained through transformation from the query graph 102 is shown on the left side. The data subgraph {v₁, v₂, v₁₀, v₁₁} that matches the query subgraph 310-1 may have an intersection with the data subgraphs {v₁, v₂, v₅, v₆}, {v₁, v₂, v₅, v₇}, and {v₁, v₂, v₈, vg} that match the query subgraph 310-2, and a result of an intersection operation is shown in 330-1 in FIG. 3C. After the intersection operation, the merged data subgraphs {v₁, v₂, v₁₀, v₁₁, v₅, v₆}, {v₁, v₂, v₁₀, v₁₁, v₅, v₇}, and {v₁, v₂, v₁₀, v₁₁, v₈, v₉} are obtained. The structures of these merged data subgraphs 340-1, 340-2, and 340-3 are shown in FIG. 3D.

Another data subgraph {v₃, v₂, v₁₀, v₁₁} that matches the query subgraph 310-1 has an intersection with the data subgraphs {v₃, v₂, v₅, v₆}{v₃, v₂, v₅, v₇} and {v₃, v₂, v₈, v₉} that match the query subgraph 310-2, and a result of an intersection operation is shown in 330-2 in FIG. 3C. After the intersection operation, the merged data subgraphs {v₃, v₂, v₁₀, v₁₁, v₅, v₆}, {v₃, v₂, v₁₀, v₁₁, v₅, v₇}, and {v₃, v₂, v₁₀, v₁₁, v₈, v₉} are obtained. The structures of these merged data subgraphs 340-4, 340-5, and 340-6 are shown in FIG. 3E.

Other data subgraphs {v₁₀, v₂, v₅, v₆}, {v₁₀, v₂, v₅, v₇}, and {v₁₀, v₂, v₈, v₉} that match the query subgraph 310-2 have no intersection with any data subgraph that matches the query subgraph 310-1, as shown in 330-3 in FIG. 3C, and therefore cannot be a search result of the query graph 102.

Different merged data subgraphs may jointly form a search result 105 of the query graph 102. In some embodiments, if a data subgraph that matches a query subgraph cannot be found in a search for the query subgraph, the distributed computation system 110 or the computation apparatus 140 may determine that the search result of the query graph 102 is a matching failure. A case in which a single query subgraph cannot find a match may include that a node and/or an edge that cannot match one or more nodes and/or edges in the query subgraph cannot be found in the data graph 130, or verification for a “non-tree edge” fails. In some embodiments, when matching of one or more query subgraphs fails and matching of other query subgraphs succeeds, data subgraphs that match the other query subgraphs may also be merged, and a partial matching search result is returned. This may also facilitate a search requester.

According to this embodiment of this application, the nodes of the query subgraphs obtained through partitioning are free of edge constraints. Therefore, when the edge constraints between the nodes are determined, whether a next node exists in a neighboring node group of the target data graph needs to be detected, so that an operation of intersecting the neighboring set can be implicitly completed, without explicit intersection in a conventional solution. In some embodiments, the query graph is partitioned based on the tree structure, matching at a same layer in the tree structure may be performed synchronously, and a depth of a tree does not exceed a length of a path of a query subgraph. Therefore, compared with a linear matching sequence applied to an existing solution, a quantity of global synchronization times may be reduced.

In addition, because the to-be-matched query subgraph is a branch path in the tree structure, partial match may be lengthened through message transfer between nodes. When edge constraints are detected, whether a node exists in a neighbor node set needs to be detected, so that an intersection operation can be implicitly completed, without explicit intersection in a conventional solution.

In addition, to reduce storage space overheads and time overheads caused by data replication, when the partial matching results are sent and received, each search process may need to store only one partial matching result. Nodes in each search process point to the partial match result by using pointers. This greatly reduces communication costs and increases a running speed.

In some embodiments, because the query graph may be partitioned into partially independent query subgraphs, this partitioning may be applied to dynamic subgraph matching. When the target data graph changes, only a matching status of an affected query subgraph needs to be adjusted, and unaffected query paths do not need to be matched again.

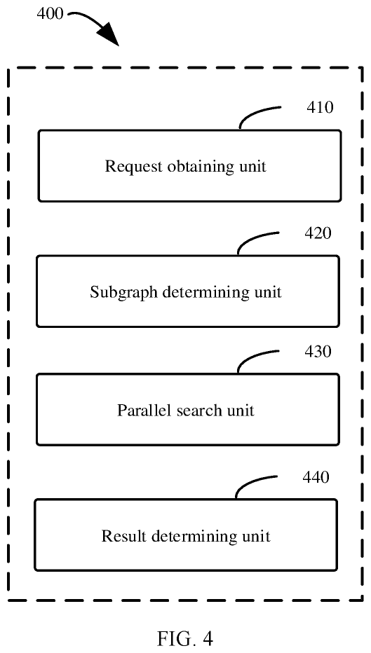

FIG. 4 is a schematic block diagram of a data search apparatus 400 according to some embodiments of this disclosure. The apparatus 400 may be implemented or included in the distributed computation environment 100 in FIG. 1A, may be implemented or included in the master node 112 and/or the worker node 114 in FIG. 1A, or may be implemented or included in the computation apparatus 140 in FIG. 1B.

The apparatus 400 may include a plurality of modules, to perform corresponding steps in the process 200 described in FIG. 2. As shown in FIG. 4, the apparatus 400 includes: a request obtaining unit 410, configured to obtain a search request, where the search request includes a query graph formed by a plurality of nodes and a plurality of edges between the plurality of nodes, each node represents an object, and each edge represents an association relationship between objects; a subgraph determining unit 420, configured to determine a plurality of query subgraphs based on the query graph, where each query subgraph includes a group of nodes in the plurality of nodes and edges between the group of nodes, and the plurality of query subgraphs have at least one same node in the plurality of nodes; a parallel search unit 430, configured to search in parallel a target data graph for data subgraphs that respectively match the plurality of query subgraphs; and a result determining unit 440, configured to merge the data subgraphs that respectively match the plurality of query subgraphs, to determine a search result that matches the query graph.

In some embodiments, the subgraph determining unit 420 includes: a tree transformation unit, configured to perform DFS on the query graph, to transform the query graph into a tree structure, where the tree structure includes the plurality of nodes in the query graph and at least a part of edges in the plurality of edges; and a tree partitioning unit, configured to partition the tree structure into the plurality of query subgraphs, where each query subgraph includes nodes and edges on a path from a root node to a leaf node of the tree structure.

In some embodiments, nodes in the plurality of query subgraphs are free of edge constraints across the query subgraphs.

In some embodiments, the parallel search unit 430 is configured to search in parallel the target data graph for data subgraphs that respectively match a first query subgraph and a second query subgraph.

In some embodiments, the tree structure does not include a first edge in the plurality of edges of the query graph, and a first query subgraph in the plurality of query subgraphs includes a pair of nodes connected through the first edge. In some embodiments, the parallel search unit 430 includes: a candidate search unit, configured to search the target data graph for a candidate data subgraph that matches the first query subgraph; a match determining unit, configured to determine whether the candidate data subgraph includes an edge that matches the first edge; and a candidate determining unit, configured to: if the candidate data subgraph includes the edge that matches the first edge, determine the candidate data subgraph as a first data subgraph that matches the first query subgraph.

In some embodiments, at least two search processes are initiated to search in parallel the target data graph for the plurality of query subgraphs.

In some embodiments, the parallel search unit 430 includes: a first control unit, configured to: if a second query subgraph and a third query subgraph in the plurality of query subgraphs include a same partial path starting from a start node, control a first search process in the at least two search processes to search the target data graph for a first partial matching subgraph that matches the same partial path; a second control unit, configured to control the first search process to search the target data graph for a second partial matching subgraph that matches a path other than the same partial path in the second query subgraph, where the first partial matching subgraph and the second partial matching subgraph are cascaded into a second data subgraph that matches the second query subgraph; and a third control unit, configured to control a second search process in the at least two search processes to search the target data graph for a third partial matching subgraph that matches a path other than the same partial path in the third query subgraph, where the first partial matching subgraph and the third partial matching subgraph are cascaded into a third data subgraph that matches the third query subgraph.

In some embodiments, at least one of the plurality of query subgraphs has a plurality of matching data subgraphs. The result determining unit 440 includes: a combination unit, configured to partition the data subgraphs that match the plurality of query subgraphs into a plurality of different combinations, where each combination includes different data subgraphs that match each of the plurality of query subgraphs; and a combination merging unit, configured to separately merge the data subgraphs included in the plurality of combinations, to obtain a plurality of merged data subgraphs as the search result.

In some embodiments, the result determining unit 440 is configured to merge, through an intersection operation, a group of data subgraphs that match each of the plurality of query subgraphs, to obtain a merged data subgraph.

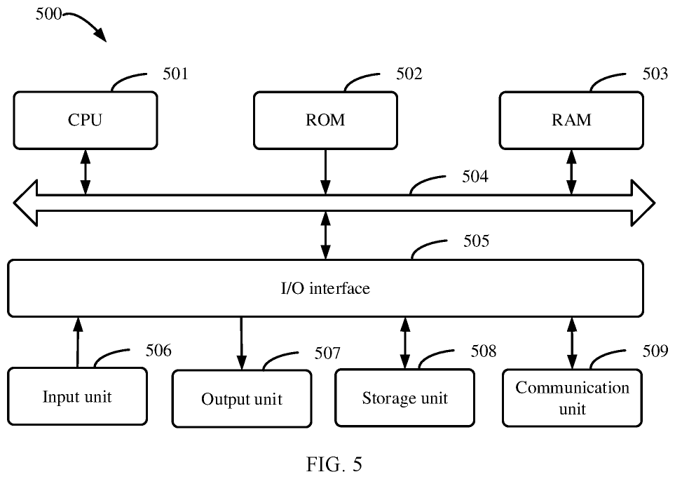

FIG. 5 is a schematic block diagram of an example device 500 that may be used to implement embodiments of this disclosure. The device 500 may be implemented or included in the distributed computation environment 100 in FIG. 1A, may be implemented or included in the master node 112 and/or the worker node 114 in FIG. 1A, or may be implemented or included in the computation apparatus 140 in FIG. 1B.

As shown, the device 500 includes a computation unit 501 that may perform various appropriate actions and processing according to computer program instructions stored in a random access memory (RAM) and/or a read-only memory (ROM) 502 or computer program instructions loaded from a storage unit 507 into a RAM and/or a ROM 502. The RAM and/or the ROM 502 may further store various programs and data required for an operation of the device 500. The computation unit 501 and the RAM and/or the ROM 502 are connected to each other through a bus 503. An input/output (I/O) interface 504 is also connected to the bus 503.

A plurality of components in the device 500 are connected to the I/O interface 504, and include: an input unit 505, for example, a keyboard or a mouse; an output unit 506, for example, various types of displays or speakers; a storage unit 507, for example, a magnetic disk or an optical disc; and a communication unit 508, for example, a network adapter, a modem, or a wireless communication transceiver. The communication unit 508 allows the device 500 to exchange information/data with another device by using a computer network such as the Internet and/or various telecommunication networks.

The computation unit 501 may be various general-purpose and/or dedicated processing components that have processing and computation capabilities. Some examples of the computation unit 501 include but are not limited to a central processing unit (CPU), a graphics processing unit (GPU), various dedicated artificial intelligence (AI) computation chips, various computation units running machine learning model algorithms, a digital signal processor (DSP), and any appropriate processor, controller, microcontroller, and the like. The computation unit 501 performs the methods and processing described above, for example, the process 200. For example, in some embodiments, the process 200 may be implemented as a computer software program, and is tangibly included in a computer-readable medium, for example, the storage unit 507. In some embodiments, a part or all of the computer program may be loaded and/or installed on the device 500 by using the RAM and/or the ROM and/or the communication unit 508. When the computer program is loaded into the RAM and/or the ROM and executed by the computation unit 501, one or more steps of the process 200 described above may be performed. Optionally, in another embodiment, the computation unit 501 may be configured to perform the process 200 in any other appropriate manner (for example, by using firmware).

Program code for implementing the method in this disclosure may be written in any combination of one or more programming languages. The program code may be provided for a processor or a controller of a general-purpose computer, a dedicated computer, or another programmable data processing apparatus, so that when the program code is executed by the processor or the controller, functions/operations specified in the flowcharts and/or the block diagrams are implemented. The program code may be completely executed on a machine, partially executed on a machine, partially executed on a machine as an independent software package, partially executed on a remote machine, or completely executed on a remote machine or a server.

In the context of this disclosure, a machine-readable medium or a computer-readable medium may be a tangible medium that may include or store programs for use by, or in combination with, an instruction execution system, apparatus, or device. The computer-readable medium may be a machine-readable signal medium or a machine-readable storage medium. The computer-readable medium may include but is not limited to an electronic, magnetic, optical, electromagnetic, infrared, or semiconductor system, apparatus, or device, or any appropriate combination of the foregoing content. More examples of a machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a compact disc read-only memory (CD-ROM), an optical storage device, a magnetic storage device, or any appropriate combination of the foregoing content.

In addition, the operations are described in an exemplary sequence. However, it should be understood that such operations should be performed in the shown sequence or in sequence, or all the operations shown in the figure should be performed to obtain a desired result. Multi-task and parallel processing may be advantageous in an exemplary environment. Similarly, although several exemplary implementation details are included in the foregoing description, these should not be construed as a limitation on the scope of this disclosure. Some features described in the context of separate embodiments may also be implemented in combination in a single implementation. Conversely, the various features described in the context of a single implementation may alternatively be implemented in a plurality of implementations, either individually or in any appropriate subcombination manner.

Although the subject matter has been described in language specific to structural features and/or methodological logical actions, it should be understood that the subject matter defined in the appended claims is not limited to the exemplary features or actions described above. On the contrary, the exemplary features and actions described above are merely example forms of implementing the claims.

What is claimed is:

1. A data search method, applied to a data search apparatus comprising at least one processor and a receiver, wherein the method comprises:
obtaining a search request by the receiver, wherein the search request comprises a query graph formed by a plurality of nodes and a plurality of edges between the plurality of nodes, each node represents an object, and each edge represents an association relationship between objects;
determining a plurality of query subgraphs, by the at least one processor, based on the query graph, wherein each query subgraph comprises a group of nodes in the plurality of nodes and edges between the group of nodes, and the plurality of query subgraphs have at least one same node in the plurality of nodes;
searching in parallel a target data graph, by the at least one processor, for data subgraphs that respectively match the plurality of query subgraphs; and
merging the data subgraphs that respectively match the plurality of query subgraphs, by the at least one processor, to determine a search result that matches the query graph.

2. The method according to claim 1, wherein the determining the plurality of query subgraphs, by the at least one processor, based on the query graph comprises:
performing depth-first search (DFS) on the query graph, by the at least one processor, to transform the query graph into a tree structure, wherein the tree structure comprises the plurality of nodes in the query graph and at least a part of edges in the plurality of edges; and
partitioning the tree structure into the plurality of query subgraphs by the at least one processor, wherein each query subgraph comprises nodes and edges on a path from a root node to a leaf node of the tree structure.

3. The method according to claim 2, wherein the tree structure does not comprise a first edge in the plurality of edges of the query graph, and a first query subgraph in the plurality of query subgraphs comprises a pair of nodes connected through the first edge; and
the searching in parallel the target data graph, by the at least one processor, for data subgraphs that respectively match the plurality of query subgraphs comprises:
searching the target data graph, by the at least one processor, for a candidate data subgraph that matches the first query subgraph;
determining, by the at least one processor, whether the candidate data subgraph comprises an edge that matches the first edge; and
responsive to determining that the candidate data subgraph comprises the edge that matches the first edge, determining the candidate data subgraph, by the at least one processor, as a first data subgraph that matches the first query subgraph.

4. The method according to claim 1, wherein at least two search processes are initiated to search in parallel the target data graph for the plurality of query subgraphs.

5. The method according to claim 4, wherein the searching in parallel the target data graph, by the at least one processor, for data subgraphs that respectively match the plurality of query subgraphs comprises:
responsive to determining that a second query subgraph and a third query subgraph in the plurality of query subgraphs comprise a same partial path starting from a start node, controlling a first search process in the at least two search processes, by the at least one processor, to search the target data graph for a first partial matching subgraph that matches the same partial path;
controlling the first search process, by the at least one processor, to search the target data graph for a second partial matching subgraph that matches a path other than the same partial path in the second query subgraph, wherein the first partial matching subgraph and the second partial matching subgraph are cascaded into a second data subgraph that matches the second query subgraph; and
controlling a second search process in the at least two search processes, by the at least one processor, to search the target data graph for a third partial matching subgraph that matches a path other than the same partial path in the third query subgraph, wherein the first partial matching subgraph and the third partial matching subgraph are cascaded into a third data subgraph that matches the third query subgraph.

6. A data search apparatus, comprising at least one processor and a receiver, wherein:
the receiver is configured to obtain a search request, wherein the search request comprises a query graph formed by a plurality of nodes and a plurality of edges between the plurality of nodes, each node represents an object, and each edge represents an association relationship between objects;
the at least one processor is configured to determine a plurality of query subgraphs based on the query graph, wherein each query subgraph comprises a group of nodes in the plurality of nodes and edges between the group of nodes, and the plurality of query subgraphs have at least one same node in the plurality of nodes;
the at least one processor is further configured to search in parallel a target data graph for data subgraphs that respectively match the plurality of query subgraphs; and
the at least one processor is further configured to merge the data subgraphs that respectively match the plurality of query subgraphs, to determine a search result that matches the query graph.

7. The apparatus according to claim 6, wherein the at least one processor comprises:
a tree transformation processor, configured to perform depth-first search (DFS) on the query graph, to transform the query graph into a tree structure, wherein the tree structure comprises the plurality of nodes in the query graph and at least a part of edges in the plurality of edges; and
a tree partitioning processor, configured to partition the tree structure into the plurality of query subgraphs, wherein each query subgraph comprises nodes and edges on a path from a root node to a leaf node of the tree structure.

8. The apparatus according to claim 7, wherein the tree structure does not comprise a first edge in the plurality of edges of the query graph, and a first query subgraph in the plurality of query subgraphs comprises a pair of nodes connected through the first edge; and
the at least one processor comprises:
a candidate search processor, configured to search the target data graph for a candidate data subgraph that matches the first query subgraph;
a match determining processor, configured to determine whether the candidate data subgraph comprises an edge that matches the first edge; and
a candidate determining processor, configured to: responsive to determining that the candidate data subgraph comprises the edge that matches the first edge, determine the candidate data subgraph as a first data subgraph that matches the first query subgraph.

9. The apparatus according to claim 6, wherein at least two search processes are initiated to search in parallel the target data graph for the plurality of query subgraphs.

10. The apparatus according to claim 9, wherein the at least one processor comprises:
a first controlling processor, configured to: responsive to determining that a second query subgraph and a third query subgraph in the plurality of query subgraphs comprise a same partial path starting from a start node, control a first search process in the at least two search processes to search the target data graph for a first partial matching subgraph that matches the same partial path;
a second controlling processor, configured to control the first search process to search the target data graph for a second partial matching subgraph that matches a path other than the same partial path in the second query subgraph, wherein the first partial matching subgraph and the second partial matching subgraph are cascaded into a second data subgraph that matches the second query subgraph; and
a third controlling processor, configured to control a second search process in the at least two search processes to search the target data graph for a third partial matching subgraph that matches a path other than the same partial path in the third query subgraph, wherein the first partial matching subgraph and the third partial matching subgraph are cascaded into a third data subgraph that matches the third query subgraph.

11. An electronic device, comprising:
at least one processor; and
at least one memory, wherein the at least one memory is coupled to the at least one processor, and stores instructions executed by the at least one processor; and when the instructions are executed by the at least one processor, the device is caused to perform:
obtaining a search request, wherein the search request comprises a query graph formed by a plurality of nodes and a plurality of edges between the plurality of nodes, each node represents an object, and each edge represents an association relationship between objects;
determining a plurality of query subgraphs based on the query graph, wherein each query subgraph comprises a group of nodes in the plurality of nodes and edges between the group of nodes, and the plurality of query subgraphs have at least one same node in the plurality of nodes;
searching in parallel a target data graph for data subgraphs that respectively match the plurality of query subgraphs; and
merging the data subgraphs that respectively match the plurality of query subgraphs, to determine a search result that matches the query graph.

12. The electronic device according to claim 11, wherein the determining the plurality of query subgraphs based on the query graph comprises:
performing depth-first search (DFS) on the query graph, to transform the query graph into a tree structure, wherein the tree structure comprises the plurality of nodes in the query graph and at least a part of edges in the plurality of edges; and
partitioning the tree structure into the plurality of query subgraphs, wherein each query subgraph comprises nodes and edges on a path from a root node to a leaf node of the tree structure.

13. The electronic device according to claim 12, wherein the tree structure does not comprise a first edge in the plurality of edges of the query graph, and a first query subgraph in the plurality of query subgraphs comprises a pair of nodes connected through the first edge; and
the searching in parallel the target data graph for data subgraphs that respectively match the plurality of query subgraphs comprises:
searching the target data graph for a candidate data subgraph that matches the first query subgraph;
determining whether the candidate data subgraph comprises an edge that matches the first edge; and
responsive to determining that the candidate data subgraph comprises the edge that matches the first edge, determining the candidate data subgraph as a first data subgraph that matches the first query subgraph.

14. The electronic device according to claim 11, wherein at least two search processes are initiated to search in parallel the target data graph for the plurality of query subgraphs.

15. The electronic device according to claim 14, wherein the searching in parallel the target data graph for data subgraphs that respectively match the plurality of query subgraphs comprises:
responsive to determining that a second query subgraph and a third query subgraph in the plurality of query subgraphs comprise a same partial path starting from a start node, controlling a first search process in the at least two search processes to search the target data graph for a first partial matching subgraph that matches the same partial path;
controlling the first search process to search the target data graph for a second partial matching subgraph that matches a path other than the same partial path in the second query subgraph, wherein the first partial matching subgraph and the second partial matching subgraph are cascaded into a second data subgraph that matches the second query subgraph; and
controlling a second search process in the at least two search processes to search the target data graph for a third partial matching subgraph that matches a path other than the same partial path in the third query subgraph, wherein the first partial matching subgraph and the third partial matching subgraph are cascaded into a third data subgraph that matches the third query subgraph.
